(19) United States
(12) Patent Application Publication
(10) Pub. No.: US 2021/0318407 A1
(43) Pub. Date: Oct. 14, 2021

(54) USER EQUIPMENT AND CONTROL METHOD

(71) Applicant: NTT DOCOMO, INC., Tokyo (JP)

(72) Inventors: Tomoya Ohara, Chiyoda-ku, Tokyo (JP); Hiroki Harada, Chiyoda-ku, Tokyo (JP); Daiki Takeda, Chiyoda-ku, Tokyo (JP)

(73) Assignee: NTT DOCOMO, INC., Tokyo (JP)

(21) Appl. No.: 17/265,115

(22) PCT Filed: Aug. 7, 2018
(86) PCT No.: PCT/JP2018/029692

§ 371 Date: Feb. 1, 2021

(51) Int. Cl. G01S 5/02

(52) U.S. Cl. CPC G01S 5/0284

(57) ABSTRACT

A user equipment comprises a transmitter configured to transmit a signal to a base station apparatus; a controller configured to determine whether an environment to the base station apparatus is a line of sight (LOS) environment. The controller changes an operation according to the determined environment, or the transmitter transmits to the base station apparatus information indicating the determined environment.

### TECHNICAL FIELD

The present invention relates to a user equipment and a control method in a wireless communication system.

### BACKGROUND ART

In NR (New Radio) (also referred to as “5G”) which is an LTE (long term evolution) successor system, technology has been discussed, which satisfies requirements to a large capacity system, a high data rate, a small latency, simultaneous connections of a number of terminals, low cost, low power or the like (e.g., Non-Patent Document 1).

As an existing position measurement technique using LTE, A-GNSS (Assisted Global Navigation Satellite System), A-GPS (Assisted Global Positioning System), ECID (Enhanced Cell ID), OTDOA (Observed Time Difference Of Arrival) or the like is defined (e.g., Non-Patent Document 2).

### RELATED-ART DOCUMENTS

### Non Patent Document

Non Patent Document 1: 3GPP TS 38.300 V15.2.0 (June 2018)
Non Patent Document 2: 3GPP TS 36.355 V15.0.0 (June 2018)

### SUMMARY OF THE INVENTION

### Problem to be Solved by the Invention

In a NR wireless communication system, particularly in a high frequency band, it is assumed to use a beamforming technique with directivity. Thus, path loss due to a reflection wave or the like may be significantly different in accordance with whether or not a state between a base station apparatus and a user equipment is a line of sight (LOS) environment, i.e., a LOS environment or a NLOS (Non-LOS) environment.

However, with regard to the above-mentioned examples of the position measurement technique, operations of a user equipment or a base station apparatus are basically determined in spite of whether an environment is a LOS environment or a NLOS environment. Therefore, there is a case to which an appropriate operation/scheme for the environment is not applied.

The present invention is made in consideration of the above-mentioned situation and an object thereof is to enable to perform operations in accordance with whether or not a state between a base station apparatus and a user equipment is a line of sight environment.

### Means to Solve the Problem

According to the disclosed technology, there is provided a user equipment comprising: a transmitter configured to transmit a signal to a base station apparatus; and a controller configured to determine whether an environment to the base station apparatus is a line of sight (LOS) environment; wherein the controller changes an operation according to the determined environment, or the transmitter transmits to the base station apparatus information indicating the determined environment.

### Advantage of the Invention

According to the disclosed technology, it is possible to perform operations in accordance with whether or not a state between a base station apparatus and a user equipment is a line of sight environment in a wireless communication system.

### BRIEF DESCRIPTION OF THE DRAWINGS

FIG. 1 is a diagram illustrating a wireless communication system in accordance with an embodiment of the present invention.

FIG. 2 is a diagram illustrating a flowchart to describe operations in accordance with an embodiment of the present invention.

FIG. 3 is a diagram illustrating an example of a functional configuration of a base station apparatus 10 in accordance with an embodiment of the present invention.

FIG. 4 is a diagram illustrating an example of a functional configuration of a user equipment 20 in accordance with an embodiment of the present invention.

FIG. 5 is a diagram illustrating an example of a hardware configuration of a base station apparatus 10 or a user equipment 20 in accordance with an embodiment of the present invention.

### MODE FOR CARRYING OUT THE INVENTION

Hereinafter, embodiments of the present invention are described with reference to drawings. Here, the embodiments described below are merely examples, and an embodiment to which the present invention is applied is not limited to the following embodiment.

With regard to operations of a wireless communication system of the present invention, an existing technique may be appropriately used. The existing technique is, for example, an existing LTE, but is not limited to the existing LTE. In addition, the term “LTE” used in this specification widely includes meanings of the LTE-Advanced and schemes after the LTE-Advanced (e.g., NR) unless otherwise particularly specified.

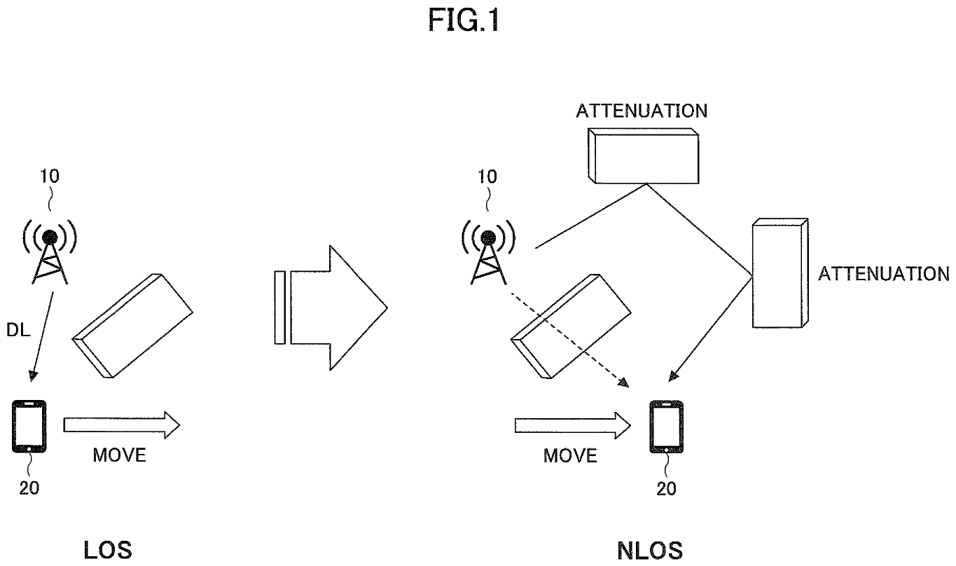

FIG. 1 is a diagram illustrating a wireless communication system in accordance with an embodiment of the present invention. As illustrated in FIG. 1, the wireless communication system in accordance with the embodiment of the present invention includes a base station apparatus 10 and a user equipment 20.

The base station apparatus 10 communicates with the user equipment 20 through a radio bearer which is established to the user equipment 20. The base station apparatus 10 may be referred to as “eNB (enhanced Node B)”, “NR (New Radio) node”, “gNB (Next generation Node B)”, or the like.

The user equipment (UE) 20 may be a terminal which frequently transmits or receives a large amount of data (which is also referred to as “MBB (Mobile Broad Band)” terminal) such as a smartphone, a terminal which occasionally transmits or receives a small amount of data (which is also referred to as “MTC (Machine Type Communication)” terminal) such as a IoT device or the like. In the embodiments of the present invention, the user equipment 20 may include a variety of types (UE categories) of UEs.

As an existing position measurement technique using LTE, A-GNSS (Assisted Global Navigation Satellite System), A-GPS (Assisted Global Positioning System), ECID (Enhanced Cell ID), OTDOA (Observed Time Difference Of Arrival) or the like may be conceived.

In the A-GNSS or the A-GPS, the position measurement is performed by combining (i) position measurement information by means of the GNSS or the GPS with (ii) assistant data by means of a network such as LTE. The assistant data is information which allows to accelerate a process to receive signals from navigation satellites, such as a visible satellite list, satellite signal Doppler information, a reference time, a reference position or the like.

The ECID is a technique to measure a position by means of information, such as a cell position in which the user equipment 20 is located, a RTT (Round Trip Time) between the user equipment 20 and the base station apparatus 10, an AoA (Angle of Arrival) or the like.

The OTDOA is a technique to measure a position of the user equipment 20 by using time difference information, measured by the user equipment 20, between downlink reference signals from plural base station apparatuses 10 and/or by using, by a base station apparatus 10, time difference information between known base station apparatuses 10 and position information of the base station apparatuses 10. A PRS (Positioning Reference Signal) may be used as a dedicated reference signal for measuring a position.

The UTDOA is a technique to measure a position by receiving at plural base station apparatuses 10 an uplink reference signal (e.g., SRS (Sounding Reference Signal)) from the user equipment 20.

In a NR wireless communication system, particularly in a high frequency band, it is postulated to use a beamforming technique with directivity. Thus, path loss due to a reflection wave or the like may be significantly different in accordance with whether or not a state between a base station apparatus and a user equipment is a line of sight (LOS) environment, i.e., a LOS environment or a NLOS (Non-LOS) environment.

For example, as illustrated in FIG. 1, when a state between the base station apparatus 10 and the user equipment apparatus 20 is a line of sight environment (LOS environment), there may not be path loss due to a reflection wave. Thus, generally, a measurement result value in the user equipment 20, such as RSRP (Reference Signal Received Power), may be high. On the other hand, when a state between the base station apparatus 10 and the user equipment apparatus 20 is not a line of sight environment (NLOS environment), there may be path loss (signal attenuation) due to a reflection wave. Thus, generally, a measurement result value in the user equipment 20, such as RSRP, may be low.

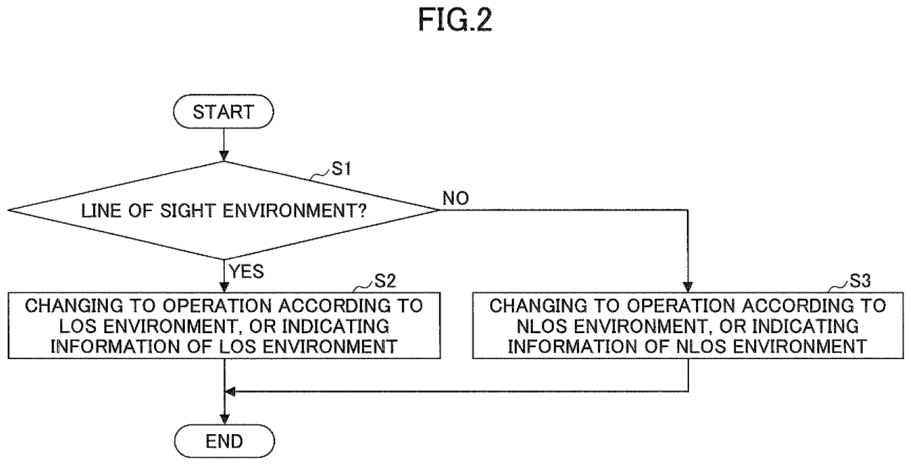

FIG. 2 is a flowchart to describe operations in accordance with an embodiment of the present invention. As illustrated in FIG. 2, in the embodiment of the present invention, the user equipment 20 determines if a state between the base station apparatus 10 and the user equipment 20 is a line of sight (LOS) environment, and changes an operation according to the determined environment, or indicates to the base station apparatus information indicating the determined environment.

In Step S1, the user equipment 20 determines whether or not a state between the base station apparatus 10 and the user equipment 20 is a line of sight (LOS) environment, i.e., a LOS environment or a NLOS environment. A method of determining whether an environment is a LOS environment or a NLOS environment will be described later.

If YES in Step S1, i.e, the state between the base station apparatus 10 and the user equipment 20 is the LOS environment, the user equipment 20 changes an operation according to the LOS environment, or indicates to the base station apparatus 10 information indicating the LOS environment (Step S2). The operation according the LOS environment will be described later.

If NO in Step S1, i.e., the state between the base station apparatus 10 and the user equipment 20 is a NLOS environment, the user equipment 20 changes an operation according to the NLOS environment, or indicates to the base station apparatus 10 information indicating the NLOS environment (Step S3). The operation according the NLOS environment will be described later.

A method of determining whether an environment is a LOS environment or a NLOS environment will be described.

(Determination Method 1)

The user equipment 20 may determine whether an environment is a LOS environment or a NLOS environment by means of information of a TA (Timing Advance) that is an adjustment value of an uplink transmission timing, a RSRP or the like, or a combination thereof.

For example, when a RSRP value is low for a TA value, a state is likely to be a NLOS environment. It may be determined to be a NLOS environment because when the user equipment 20 is near the base station apparatus 10 and their state is a LOS environment, the TA value will be low while the RSRP value will be high. However, when the user equipment 20 is near the base station apparatus 10 and their state is a NLOS environment, the TA value will be low and the RSRP value will also be low because there is attenuation due to a reflection wave or the like.

(Determination Method 2)

The user equipment 20 may determine whether an environment is a LOS environment or a NLOS environment based on an amount of change of a value such as a TA value and/or a measurement result value such as RSRP, RSRQ (Reference Signal Received Quality), SINR (Signal to Interference plus Noise Ratio) or the like.

For example, when a measurement result value and/or a TA value drastically changes, it may be determined that an environment of a LOS environment or a NLOS environment changes. When a trend of the measurement result value and/or the TA value is more changed than a previous trend, it may be determined that the environment of the LOS environment or the NLOS environment changes. For example, when a ratio of a RSRP value to a TA value largely changes, it may be determined that an environment of a LOS environment or a NLOS environment changes.

In addition, the user equipment 20 may determine whether an environment is a LOS environment or a NLOS environment by combining Determination Method 1 with Determination Method 2.

(Determination Method 3)

The user equipment 20 may determine whether an environment is a LOS environment or a NLOS environment based on information of coordinates of the base station apparatus 10 or a transmission power of the base station apparatus 10 which are indicated from the base station apparatus 10.

For example, the user equipment 20 may determine whether an environment is a LOS environment or a NLOS environment by comparing coordinates of the base station apparatus 10 with coordinates of the user equipment 20 and by comparing a transmission power of the base station apparatus 10 with a transmission power of the user equipment 20.

In addition, the user equipment 20 may determine whether an environment is a LOS environment or a NLOS environment by combining Determination Method 3 with Determination Method 1 and/or Determination Method 2.

In addition, with regard to Determination Method 1, Determination Method 2 and Determination Method 3 or the like, criteria to determine whether an environment is a LOS environment or a NLOS environment may be previously determined as a standard, or indicated from the base station apparatus 10 to the user equipment 20.

With regard to Determination Method 1, Determination Method 2 and Determination Method 3 or the like, the criteria may be determined based on a relative value (e.g., a relative value of a RSRP value to a TA value), or respective absolute values.

Next, a method of changing an operation according to the determined environment in Step S2 and Step S3 (FIG. 2) will be described.

A position measurement scheme used in the user equipment 20 may be switched according to the determined environment. For example, the ECID or the like may be used as a position measurement scheme when the determined environment is a LOS environment while the A-GNSS or the like may be used as a position measurement scheme when the determined environment is a NLOS environment. When the determined environment is the NLOS environment, for example, information related to a beam (e.g., SS block index information) may further be used (or indicated to the base station apparatus 10).

When the determined environment is a LOS environment, with regard to a measurement operation such as Measurements, Radio Link Monitoring or the like, a load of the user equipment 20 may be reduced because a communication environment is considered to be good. As an example of reducing a load of measurement operations, it is conceivable to make a measurement cycle long, to reduce the number of beams, to reduce an accuracy, to reduce the number of samples required for measurements or the like. This operation change may be defined as a requirement required for a terminal standard, or such operations may be defined.

For example, when the determined environment is a NLOS environment, an event such as Measurement and/or an operation such as Radio Link Monitoring may be initiated by the user equipment 20. That is, the determination of NLOS environment may trigger the user equipment to initiate/start a predetermined operation.

For example, the number of MIMO layers may be switched in accordance with whether the determined environment is a LOS environment or a NLOS environment. For example, when the determined environment is the NLOS environment, the number of MIMO layers may be reduced because a communication environment may be severe.

For example, with regard to the number of MIMO layers, when a rank is indicated from the user equipment 20 to the base station apparatus 10, the rank may be indicated together with information indicating whether an environment is a LOS environment or a NLOS environment. When a rank is indicated together with information indicating whether an environment is a LOS environment or a NLOS environment, for example, there may be four patterns of options for a rank, i.e., rank 1, rank 2, rank 3 and rank 4 when a LOS environment is indicated while there may be only one pattern of rank 1 for a rank when a NLOS environment is indicated. By restricting patterns to five patterns in total, it may be possible to reduce the number of bits required for the indication. Here, the rank is only rank 1 when the NLOS environment is indicated because it may be conceivable to use only a low rank in the NLOS environment.

For example, even when a rank is normally indicated by the user equipment 20, the number of MIMO layers may be determined (e.g. 1 layer) without referring to the rank and/or an indication from a base station apparatus when the environment determined by the user equipment 20 is a NLOS environment.

For example, a measurement result such as a RSRP may be reported together with information indicating whether an environment is a LOS environment or a NLOS environment. When a measurement result is reported together with information indicating whether an environment is a LOS environment or a NLOS environment, for example, it is conceivable that a receivable RSRP is low in case of a NLOS environment. Thus, a RSRP range reported together with information indicating a NLOS environment may be a lower part of the RSRP range. In addition, a RSRP range reported together with information indicating a LOS environment may be an entire RSRP range or a higher part of the RSRP range.

An information element indicated together with information indicating whether an environment is a LOS environment or a NLOS environment is not limited to the above-mentioned example. Another information element may be indicated together with information indicating whether an environment is a LOS environment or a NLOS environment.

With regard to Step S2 and/or Step S3 in FIG. 2 performed by the user equipment 20, changing an operation according to the determined environment, or indicating to the base station apparatus 10 information indicating the determined environment may be restrictively applied according to a predetermined element.

For example, changing an operation according to the determined environment, or indicating to the base station apparatus 10 information indicating the determined environment may be restrictively applied according to a frequency band. For example, the step of changing or indicating may be applied to only a case of a high frequency band.

Changing an operation according to the determined environment, or indicating to the base station apparatus 10 information indicating the determined environment may be restrictively applied according to cell information. For example, the step of changing or indicating may be restrictively applied only to a SCell. Alternatively the step of changing or indicating may be restrictively applied only to a PCell.

Changing an operation according to the determined environment, or indicating to the base station apparatus 10 information indicating the determined environment may be restrictively applied according to a configuration for a base station apparatus (e.g., an antenna array or the like).

Whether changing an operation according to the determined environment is applied, or whether indicating to the base station apparatus 10 information indicating the determined environment is applied may be indicated from the base station apparatus 10.

(Device Configuration)

Next, functional configuration examples of the base station apparatus 10 and the user equipment 20 which perform the processing and operations described above will be described. Each of the base station apparatus 10 and the user equipment 20 includes functions implementing the described example. However, each of the base station apparatus 10 and the user equipment 20 may comprise only some functions in the example.

<Base Station Apparatus 10>

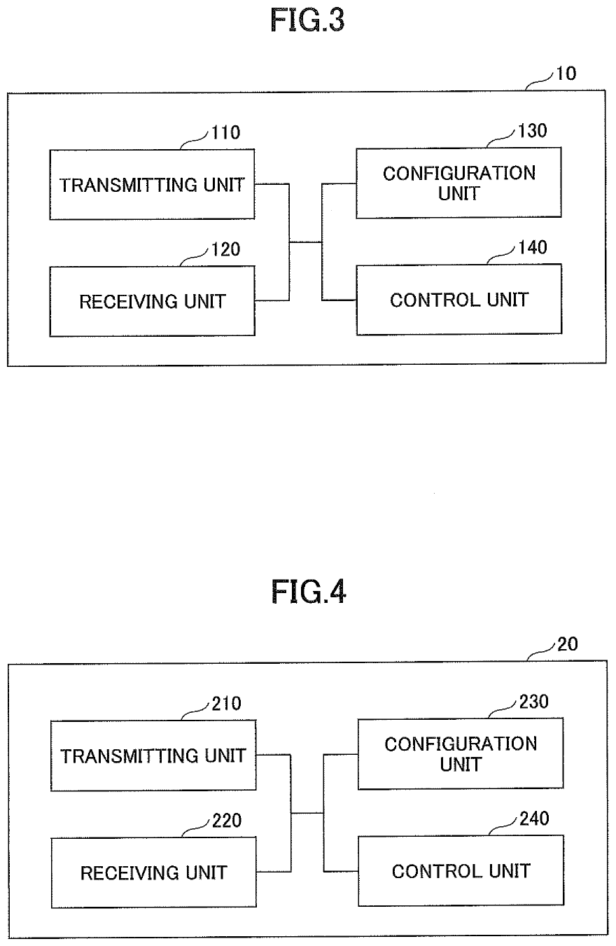

FIG. 3 is a diagram illustrating an example of a functional configuration of the base station apparatus 10. As illustrated in FIG. 3, the base station apparatus 10 comprises a transmitting unit 110, a receiving unit 120, a configuration unit 130, and a control unit 140. The functional configuration illustrated in FIG. 3 is merely an example. Any of functional sections and names of functional units may be used as long as the operations according to an embodiment of the present invention can be performed.

The transmitting unit 110 includes a function that generates a signal to be transmitted to the user equipment 20 side and wirelessly transmits the signal. The receiving unit 120 includes a function that receives various signals transmitted from the user equipment 20 and, for example, obtains information of a higher layer from the received signal. In addition, the receiving unit 120 receives information indicating whether a state between the base station 10 and the user equipment 20 is a LOS environment or a NLOS environment.

The configuration unit 130 stores preset configuration information and various pieces of configuration information to be transmitted to the user equipment 20, and read out from a memory device if necessary.

The control unit 140 indicates coordinates and a transmission power of the base station apparatus to the user equipment via the transmitting unit 110, as described in the embodiment. The transmitting unit 110 may include a functional unit in relation to a signal transmission in the control unit 140 while the receiving unit 120 may include a functional unit in relation to a signal reception in the control unit 140.

<User Equipment 20>

FIG. 4 is a diagram illustrating an example of a functional configuration of the user equipment 20. As illustrated in FIG. 4, the user equipment 20 comprises a transmitting unit 210, a receiving unit 220, a configuration unit 230, and a control unit 240. The functional configuration illustrated in FIG. 4 is merely an example. Any of functional sections and names of functional units may be used as long as the operations according to an embodiment of the present invention can be performed.

The transmitting unit 210 generates a transmission signal from transmit data and wirelessly transmits the transmit signal. The receiving unit 220 wirelessly receives various signals and obtains a signal of a higher layer from the received physical layer signal. The receiving unit 220 receives information of coordinates of the base station apparatus 10 and/or a transmission power of the base station apparatus 10 which are transmitted from the base station apparatus 10.

The configuration unit 230 stores various pieces of configuration information received by means of the receiving unit 220 from the base station apparatus 10 or the user equipment 20, and read out from a memory device if necessary. In addition, the configuration unit 230 also stores predetermined configuration information. Content of the configuration information may be, for example, a configuration for a base station apparatus (e.g., an antenna array or the like).

The control unit 240 determines whether or not a state between the base station 10 and the user equipment 20 is a line of sight environment, i.e., a LOS environment or a NLOS environment, as described in the embodiment. In addition, in accordance with whether the environment is the LOS environment or the NLOS environment, the control unit 240 changes an operation according to the environment or indicates to the base station apparatus 10 information indicating the determined environment.

(Hardware Configuration)

The functional configuration diagrams (FIG. 3 and FIG. 4) used in the description of the embodiment of the present invention described above illustrate blocks in the units of functions. These functional blocks (constituent units) are embodied in any combination of hardware and/or software. A manner for embodying each functional block is not particularly limited. That is, each functional block may be embodied by means of one device into which a plurality of elements are physically and/or logically coupled, or may be embodied by plural devices that are physically and/or logically separated and that are connected directly and/or indirectly (for example, in a wired and/or wireless manner). The functional blocks may be implemented by including software into the one or more devices.

The function may include, but is not limited to, determining, deciding, judging, calculating, computing, processing, deriving, investing, looking up, ascertaining, receiving, transmitting, outputting, accessing, resolving, selecting, choosing, establishing, comparing, assuming, expecting, considering, broadcasting, notifying, communicating, forwarding, configuring, reconfiguring, allocating, mapping, assigning and the like. For example, a functional block (configuration unit) allowing to function to transmit a signal may be referred to as “transmitting unit” or “transmitter”. As described above, the implementation is not particularly limited.

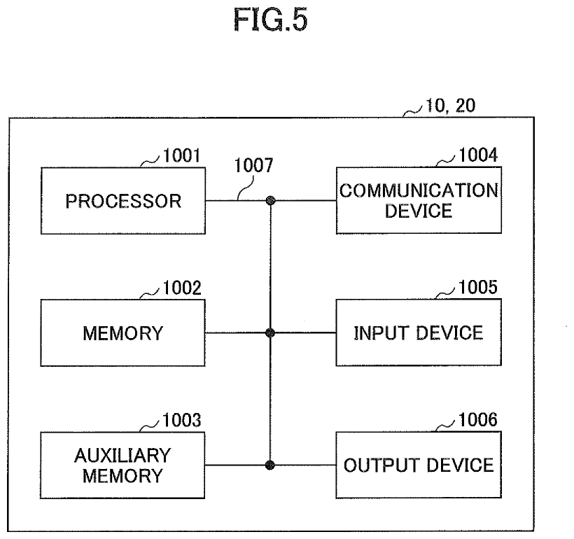

For example, any of the base station apparatus 10, the user equipment 20 and the like in an embodiment of the present invention may function as a computer in which performs the processes according to the embodiment of the present invention. FIG. 5 is a diagram illustrating an example of a hardware configuration of a base station apparatus 10 and a user equipment 20 according to an embodiment of the present invention. Each of the base station apparatus 10 and the user equipment 20 described above may be physically configured as a computer device including a processor 1001, a memory 1002, an auxiliary memory 1003, a communication device 1004, an input device 1005, an output device 1006, a bus 1007 and so on.

In the following description, the term “device” may be interchanged with a circuit, an apparatus, a unit, or the like. The hardware configurations of the base station apparatus 10 and the user equipment 20 may be arranged to include one or more of the devices 1001-1006 illustrated in the figure, or may be arranged not to include some of the devices.

Respective functions in the base station apparatus 10 and the user equipment 20 are realized by causing hardware such as the processor 1001 and the memory 1002 to read predetermined software (program) and causing the processor 1001 to perform computation and to control communication by the communication device 1004 and to control at least one of reading and/or writing of data in the memory 1002 and the auxiliary memory 1003.

The processor 1001 controls the entire computer, for example, by operating an operating system. The processor 1001 may be constituted by a central processing unit (CPU) including an interface with peripheral devices, a control device, a computation device, a register or the like.

The processor 1001 reads a program (program codes), a software module, data or the like from at least one of the auxiliary memory 1003 and/or the communication device 1004 to the memory 1002, and performs various processing operations in accordance therewith. As a program, the program causing a computer to perform at least a part of the operations described in the embodiment described above is used. For example, the transmitting unit 110, the receiving unit 120, the configuration unit 130, and the control unit 140 of the base station apparatus 10 illustrated in FIG. 3 may be embodied by means of a control program that is stored in the memory 1002 and operated by the processor 1001. Also, for example, the transmitting unit 210, the receiving unit 220, the configuration unit 230, and the control unit 240 of the user equipment 20 illustrated in FIG. 4 may be embodied by a control program that is stored in the memory 1002 and operated by the processor 1001. Although the various processing operations have been described as being performed by a single processor 1001, the various processing operations may be simultaneously or sequentially performed by two or more processors 1001. The processor 1001 may be implemented as one or more chips. The program may be transmitted from a network via an electric communication line.

The memory 1002 is a computer-readable recording medium and may be constituted, for example, by at least one of an ROM (Read Only Memory), an EPROM (Erasable Programmable ROM), an EEPROM (Electrically Erasable Programmable ROM), a RAM (Random Access Memory) or the like. The memory 1002 may be called as a register, a cache, or a main memory (a main storage device) or the like. The memory 1002 can store a program (program codes), a software module or the like that can be executed to perform operations according to an embodiment of the present invention.

The auxiliary memory 1003 is a computer-readable recording medium and may be constituted, for example, by at least one of an optical disc such as a CD-ROM (Compact Disc ROM), a hard disk drive, a flexible disk, a magneto-optical disk (such as a compact disk, a digital versatile disk, or a Blu-ray (registered trademark) disk), a smart card, a flash memory (such as a card, a stick, or a key drive), a floppy (registered trademark) disk, a magnetic strip or the like. The auxiliary memory 1003 may be called as an auxiliary storage device. The recording medium may be a database including at least one of the memory 1002 and the auxiliary memory 1003, a server, or another appropriate medium.

The communication device 1004 is hardware (a transceiver device) for performing communications between computers via at least one of a wired network and a wireless network and is referred to as, for example, a network device, a network controller, a network card, a communication module or the like. The communication device 1004 may be configured to include a high frequency switch, a duplexer, a filer, a frequency synthesizer and the like in order to implement at least one of FDD (Frequency Division Duplex) and TDD (Time Division Duplex) schemes. For example, the transmitting unit 110 and the receiving unit 120 of the base station apparatus 10 may be embodied by the communication device 1004. The transmitting unit 210 and the receiving unit 220 of the user equipment 20 may be embodied by the communication device 1004.

The input device 1005 is an input device (for example, a keyboard, a mouse, a microphone, a switch, a button, a sensor or the like) that receives an input from the outside. The output device 1006 is an output device (for example, a display, a speaker, an LED lamp or the like) that performs outputting to the outside. The input device 1005 and the output device 1006 may be configured to be integrated (such as a touch panel).

The respective devices such as the processor 1001 and the memory 1002 are connected to each other via the bus 1007 for transferring information. The bus 1007 may be constituted by a single bus, or may be configured by different buses between the devices.

Each of the base station apparatus 10 and the user equipment 20 may be configured to include hardware such as a microprocessor, a DSP (Digital Signal Processor), an ASIC (Application Specific Integrated Circuit), a PLD (Programmable Logic Device), an FPGA (Field Programmable Gate Array) or the like, and some or all of respective functional blocks may be embodied by the hardware. For example, the processor 1001 may be implemented by means of at least one of these hardware modules.

### Summary of Embodiments

As described above, according to an embodiment of the present invention, there is provided a user equipment (UE) comprising: a receiver for receiving a signal from a base station apparatus; a transmitter configured to transmit a signal to the base station apparatus; and a controller for determining whether a state between the base station apparatus and the user equipment is a LOS environment or a NLOS environment; wherein the UE changes an operation according to the determined environment, or transmits to the base station apparatus information indicating the determined environment.

According to this configuration, the user equipment 20 is able to operate in accordance with whether an environment is a LOS environment or a NLOS environment.

According to an embodiment of the present invention, the user equipment 20 is able to determine whether a state between the base station apparatus and the user equipment is a LOS environment or a NLOS environment based on a combination of TA (Timing Advance) and measurement results such as RSRP, an amount of change of the TA or the measurement result, or coordinates and a transmission power of the base station apparatus 10 which are indicated from the base station apparatus 10.

According to an embodiment of the present invention, the user equipment 20 is able to switch to an appropriate operation in accordance with whether a state between the base station apparatus 10 and the user equipment 20 is a LOS environment or a NLOS environment.

According to an embodiment of the present invention, with regard to operations of the user equipment in accordance with whether a state between the base station apparatus 10 and the user equipment 20 is a LOS environment or a NLOS environment, the operations may be restrictively applied according to a frequency band, cell information, a configuration for the base station apparatus, or an indication from the base station apparatus indicating whether applicable.

### Supplement of Embodiments

While the embodiments of the present invention have been described above, the disclosed inventions are not limited to the embodiments, but it could be understood by those skilled in the art that various modifications, alterations, alternatives, replacements, or the like can be made thereto. While specific numerical examples have been used to facilitate understanding of the present invention, the numerical values are only examples and any appropriate value may be used, unless otherwise specified. The sorting of articles in the above description is not essential to the present invention, but matters described in two or more articles may be combined for use if necessary, or matters described in a certain article may be applied to matters described in another article (unless incompatible). The boundaries of the functional units or the processing units in the functional block diagrams do not necessarily correspond to boundaries of physical components. Operations of two or more functional units may be performed physically by a single component or an operation of a single functional unit may be performed physically by two or more physical components. Regarding the processing procedure described in the embodiment, the order of the processing operations may be changed unless incompatible. For convenience of explanation of the processing, the base station apparatus 10 and the user equipment 20 have been described using the functional block diagrams, but such devices may be embodied in hardware, software, or a combination thereof. Software operated by the processor of the base station apparatus 10 according to the embodiment of the present invention and software operate by the processor of the user equipment 20 according to the embodiment of the present invention may be stored in a random access memory (RAM), a flash memory, a read only memory (ROM), an EPROM, an EEPROM, a register, a hard disk (HDD), a removable disk, a CD-ROM, a database, a server, or any other appropriate storage medium.

Notification of information is not limited to the aspects/embodiments described in this specification, but may be performed using other methods. For example, the notification of information may be performed by physical layer signaling (such as DCI (Downlink Control Information), UCI (Uplink Control Information) or the like), higher layer signaling (such as RRC (Radio Resource Control) signaling, MAC (Medium Access Control) signaling, broadcast information (MIB (Master Information Block), SIB (System Information Block) or the like), other signals, or any combination thereof. The RRC signaling may be called as an RRC message and may be, for example, an RRC connection setup message, an RRC connection reconfiguration message, or the like.

The aspects/embodiments described in this disclosure may be applied to at least one of systems utilizing LTE (Long Term Evolution), LTE-A (LTE-Advanced), SUPER 3G, IMT-Advanced, 4G (4th generation mobile communication system), 5G (5th generation mobile communication system), FRA (Future Radio Access), W-CDMA (registered trademark), GSM (registered trademark), CDMA2000, UMB (Ultra Mobile Broadband), IEEE 802.11 (Wi-Fi), IEEE 802.16 (WiMAX), IEEE 802.20, UWB (Ultra-WideBand), Bluetooth (registered trademark), or other appropriate systems and next-generation systems which is enhanced based on these systems. In addition, the present invention may be applied to a combination of plural systems (e.g., a combination of the 5G and at least one of the LTE and the LTE-A).

The processing procedures, sequences, flowcharts or the like of the aspects/embodiments described in this specification may be changed in the order as long as they are not incompatible with each other. For example, in the method described in this specification, various step elements are presented in an exemplary order and the method is not limited to the presented order.

The specific operations which are performed by the base station apparatus 10 in this specification may be performed by an upper node thereof in some cases. In a network comprising one or more network nodes including the base station apparatus 10, it is obvious that various operations which are performed to communicate with the user equipment 20 can be performed by the base station apparatus 10 and/or another network node (for example, an MME or an S-GW may be conceivable but the network node is not limited thereto) other than the base station apparatus 10. Although a case where the number of network nodes other than the base station apparatus 10 is one has been illustrated above, a combination of two or more other network nodes (for example, an MME and an S-GW) may be used.

The aspects/embodiments described in this specification may be used alone, may be used in combination, or may be switched with implementation thereof.

The user equipment 20 may also be called as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or any other appropriate term.

The base station apparatus 10 may be called as an NB (NodeB), an eNB (enhanced NodeB), a gNB, a base station, or some other appropriate terms.

The terms “determining” and “deciding” as used in this specification may include various types of operations. For example, “determining” and “deciding” may include, for example, events in which events such as judging, calculating, computing, processing, deriving, investigating, looking up (or search, inquiry) (e.g., searching in a table, a database, or another data structure), or ascertaining are regarded as “determining” or “deciding”. Further, “determining” and “deciding” may include, for example, events in which events such as receiving (e.g., reception of information), transmitting (e.g., transmission of information), input, output, or accessing (e.g., accessing data in a memory) are regarded as “determining” or “deciding”. Furthermore, “determining” and “deciding” may include, for example, events in which events such as resolving, selecting, choosing, establishing, comparing or the like are regarded as “determining” or “deciding”. In other words, “determining” and “deciding” may include events in which a certain operation is regarded as “determining” or “deciding”. In addition, “determining (deciding)” may be interchanged with “assuming”, “expecting”, “considering” or the like.

A phrase “on the basis of” used in this specification is not limited to “on the basis of only” unless otherwise stated. That is, a phrase “on the basis of” may means both “on the basis of only” and “on the basis of at least”.

As long as the terms “include” and “including” and derivatives thereof are used in this specification or the appended claims, the these terms are intended to have a comprehensive meaning similar to a term “comprising”. Further, the term “or” as used in this specification or the appended claims is intended not to be an exclusive disjunction.

In the entire disclosure, for example, when an article such as “a”, “an” or “the” is added in translation into English, such an article may include the plural unless it is obviously indicated that such an article does not include the plural.

Although the present invention has been described in detail, it is obvious for those skilled in the art that the present invention is not limited to the embodiments described in this specification. The present invention can be implemented as modifications and alterations without departing from the spirit and scope of the present invention defined in the description of the claims. Therefore, the description in this specification is intended to be exemplary and does not have any restrictive meaning to the present invention.

### LIST OF REFERENCE SYMBOLS

10 Base station apparatus
110 Transmitting unit
120 Receiving unit
130 Setting unit
140 Control unit
User equipment
210 Transmitting unit
220 Receiving unit
230 Setting unit
240 Control unit
1001 Processor
1002 Memory
1003 Auxiliary memory
1004 Communication device
1005 Input device
1006 Output device

1. A user equipment comprising:
a transmitter configured to transmit a signal to a base station apparatus; and
a controller configured to determine whether an environment to the base station apparatus is a line of sight (LOS) environment;
wherein the controller changes an operation according to the determined environment, or the transmitter transmits to the base station apparatus information indicating the determined environment.

2. The user equipment as claimed in claim 1, wherein the controller switches a position measurement scheme according to the determined environment.

3. The user equipment as claimed in claim 1, wherein the controller determines whether an environment to the base station apparatus is a line of sight (LOS) environment based on:
a combination of a measurement result and an adjustment value of an uplink transmission timing;
an amount of change of a measurement result or an adjustment value of an uplink transmission timing; or
coordinates and a transmission power of the base station apparatus which are indicated from the base station apparatus.

4. The user equipment as claimed in claim 1, wherein changing, by the controller, an operation according to the determined environment, or transmitting, by the transmitter, to the base station apparatus information indicating the determined environment is restrictively applied according to:
a frequency band;
cell information;
a configuration for the base station apparatus; or
an indication from the base station apparatus indicating whether applicable.

5. A method of controlling a user equipment, comprising:
transmitting a signal to a base station apparatus;
determining whether an environment to the base station apparatus is a line of sight (LOS) environment; and
changing an operation according to the determined environment, or transmitting to the base station apparatus information indicating the determined environment.
